(19) United States
(12) Patent Application Publication
(10) Pub. No.: US 2013/0321373 A1
(43) Pub. Date: Dec. 5, 2013

(54) ELECTRONIC DEVICE, PROGRAM, AND RECORDING MEDIUM

(71) Applicant: Semiconductor Energy Laboratory Co., Ltd., Atsugi-shi (JP)

(72) Inventor: Kensuke YOSHIZUMI, Isehara (JP)

(73) Assignee: Semiconductor Energy Laboratory Co., Ltd., Atsugi-shi (JP)

(21) Appl. No.: 13/895,594

(22) Filed: May 16, 2013

(30) Foreign Application Priority Data
May 31, 2012 (JP) 2012-124468

(51) Int. Cl. G09G 5/00

(52) U.S. Cl. CPC G09G 5/00
USPC 345/211

(57) ABSTRACT

Reliability of a flexible electronic device is improved. Damage due to curving in a flexible electronic device is prevented. The present inventor has reached an idea of setting an allowable value of a radius of curvature at the time of curving a flexible electronic device. The electronic device includes a sensing portion which determines a three-dimensional shape of the curved region. When a curving with a radius of curvature smaller than the allowable radius of curvature is detected, an alert is sent to a user.

### BACKGROUND OF THE INVENTION

1. Field of the Invention

The present invention relates to an electronic device having flexibility. The present invention relates to a program used for the electronic device and a recording medium which records the program.

2. Description of the Related Art

In recent years, highly functional portable electronic devices, examples of which are portable information terminals such as a mobile phone, a smartphone, and a tablet personal computer, a portable music reproduction device, and a portable game machine, have been rapidly developed.

For such portable electronic devices, as well as multifunctionality of the devices, development in terms of forms of the devices, such as a reduction in size or weight, is also being pursued. As one example of next-generation portable electronic devices, a flexible electronic device in the form of a sheet can be given.

For example, Patent Document 1 discloses a display input device which includes a flexible display portion and a deformation detection portion containing a material whose resistance varies with pressure. The display input device detects deformation owing to the flexibility as change in electrical characteristics, thereby utilizing deformation as an input means.

### REFERENCE

### Patent Document

[Patent Document 1] Japanese Published Patent Application No. 2004-46792

### SUMMARY OF THE INVENTION

In a flexible electronic device such as an electronic device which includes a display device provided with a flexible display screen, the mechanical strength can be increased by devising a material of a housing of the electronic device or an exterior material of the display device. However, regardless of how high the exterior mechanical strength is, stress accompanying curving of the electronic device might cause damage to a circuit, a wiring, a display element, or the like which is provided in the display device or the like of the electronic device. Moreover, a connection portion at which electrodes are electrically connected or an electrode and a wiring are electrically connected might be separated, whereby electrical insulation is caused.

Against such a technical background, an object of one embodiment of the present invention is to improve reliability of a flexible electronic device. An object of one embodiment of the present invention is to prevent damage due to curving in a flexible electronic device.

An allowable value of a radius of curvature at the time of curving a flexible electronic device is set. The electronic device is provided with a sensing portion which determines a three-dimensional shape of the curved region. When curving with a radius of curvature smaller than the allowable radius of curvature is detected, an alert is sent to a user.

That is, one embodiment of the present invention is a flexible electronic device which includes a display device provided with a display screen; a sensor which measures a parameter defining a three-dimensional shape of a curved region of the electronic device; and a processor which calculates the minimum radius of curvature in the curved region on the basis of the parameter measured by the sensor and transmits a control signal for stopping a display on the display screen when the minimum radius of curvature is smaller than a first allowable value.

With such a structure, the electronic device can be prevented from being curved with a radius of curvature smaller than the allowable value, damage to the device due to curving can be prevented, and the reliability can be improved. In addition, damage to a display element or a circuit included in the display screen which results from curving can be prevented, so that a highly reliable electronic device capable of an image display can be obtained.

The stopping of a display on the display screen can make a user receive an alert intuitively. Since an alert is generated by stopping a display, a means for switching to an alert display, image data used for the alert display, and the like are not needed, so that the speed of processing for generating an alert can be increased.

Further, it is preferable that the control signal for stopping a display on the display screen be a control signal for stopping power supply to the display device.

The stopping of power supply to the display device can prevent fatal defects such as an electrical short circuit which is caused when high stress is put with voltage applied to a circuit element, a display element, or the like of a driver circuit or a pixel in the display device. In addition, the stopping of power supply to the display device including the display screen leads to a reduction in power consumption in a period in which the alert is generated.

The above processor preferably stores, in a memory device, display data displayed on the display screen before transmitting the control signal for stopping a display on the display screen.

When the display data just before the stopping of a display is stored in the memory device in advance, an immediate return to a display state just before the stopping of a display can be performed; therefore, the alert can be generated without stress put on a user.

Further, it is preferable that the above electronic device further include an alert generating means which generates an alert and the processor transmit a control signal for generating an alert from the alert generating means.

When the stopping of a display on the display screen and the generation of an alert by another alerting means are thus combined, a user can receive the alert in a more effective way.

It is preferable that the alert from the above alert generating means be at least one of a display on the display screen, a sound from a sound output means, vibration by a vibration means, and light emission by a light-emitting means.

By performing an alert display on the display screen, it is possible to make a user receive the alert intuitively; accordingly, curving with a radius of curvature smaller than the allowable value can be more effectively prevented. Besides, a sound can also be used to make a user receive an alert intuitively. In addition, vibration can also be used to make a user receive an alert intuitively. Vibration is preferably used, in which case an alert can be sent to a user even in a situation where a sound cannot be output. Light emission from the light-emitting means can also be used to make a user receive an alert intuitively. Light emission is preferably used, in which case an alert can be sent to a user even in a situation where a sound cannot be output or a situation where lighting is too dim to make a state of the electronic device visible.

Further, in the above electronic device, it is preferable that the processor transmit a control signal for generating an alert from the alert generating means when the minimum radius of curvature is larger than the first allowable value and smaller than a second allowable value which is larger than the first allowable value.

As described above, the two allowable values of radii of curvature are set, and an alert is generated from the alert generating means when curving with a radius of curvature smaller than the second allowable value is performed; and a display on the display screen is stopped or power supply to the display device is stopped when curving with a radius of curvature smaller than the first allowable value is performed. The setting of the plurality of allowable values of radii of curvature facilitates recognition of the allowable values by a user, which makes it possible to more effectively prevent the electronic device from being damaged by being excessively curved.

Further, it is preferable that the above processor transmit a control signal for stopping a display on the display screen and a control signal for generating an alert from the alert generating means so that a period in which the display on the display screen is stopped overlaps with a period in which the alert is generated from the alert generating means.

When a display on the display screen is stopped at the same time as the alert operation by the alert generating means as described above, a user can receive the alert in a more effective way.

Another embodiment of the present invention is a program for making a flexible electronic device including a display device provided with a display screen, a sensor, and a processor execute processing in which the sensor measures a parameter defining a three-dimensional shape of a curved region of the electronic device; and processing in which the processor calculates the minimum radius of curvature in the curved region on the basis of the parameter measured by the sensor and transmits a control signal for stopping a display on the display screen when the minimum radius of curvature is smaller than a first allowable value.

A further embodiment of the present invention is a computer-readable recording medium recording a program for making a flexible electronic device including a display device provided with a display screen, a sensor, and a processor execute processing in which the sensor measures a parameter defining a three-dimensional shape of a curved region of the electronic device; and processing in which the processor calculates the minimum radius of curvature in the curved region on the basis of the parameter measured by the sensor and transmits a control signal for stopping a display on the display screen when the minimum radius of curvature is smaller than a first allowable value.

In this specification and the like, a flexible electronic device refers to an electronic device which can operate in a state where it is curved. It is not always necessary that the whole electronic device has flexibility; the flexible electronic device includes, in its category, an electronic device at least part of which is flexible.

According to one embodiment of the present invention, reliability of a flexible electronic device can be improved. Alternatively, damage due to curving in a flexible electronic device can be prevented.

### BRIEF DESCRIPTION OF THE DRAWINGS

FIGS. 1A to 1D illustrate a structure example of an electronic device of one embodiment of the present invention.

FIG. 2 illustrates a structure example of an electronic device of one embodiment of the present invention.

FIG. 3 is a block diagram illustrating a hardware structure of an electronic device of one embodiment of the present invention.

FIGS. 4A1, 4A2, 4B1, 4B2, 4C1, and 4C2 illustrate examples of alert operation in an electronic device of one embodiment of the present invention.

FIGS. 5A and 5B illustrate examples of alert operation in an electronic device of one embodiment of the present invention.

FIG. 6 is a flow chart illustrating an example of operation of an electronic device of one embodiment of the present invention.

### DETAILED DESCRIPTION OF THE INVENTION

Embodiments will be described in detail with reference to the accompanying drawings. Note that the invention is not limited to the following description, and it will be easily understood by those skilled in the art that various changes and modifications can be made without departing from the spirit and scope of the invention.

Therefore, the invention should not be construed as being limited to the description in the following embodiments. Note that in the structures of the invention described below, the same portions or portions having similar functions are denoted by the same reference numerals in different drawings, and description of such portions is not repeated.

Note that in each drawing described in this specification, the size, the thickness, or the region of each component is exaggerated for clarity in some cases. Therefore, embodiments of the present invention are not limited to such scales.

### Embodiment 1

In this embodiment, a structure example of an electronic device of one embodiment of the present invention is described with reference to drawings. In this embodiment, one example of a structure of an electronic device provided with a flexible display screen will be described.

### [Structure Example]

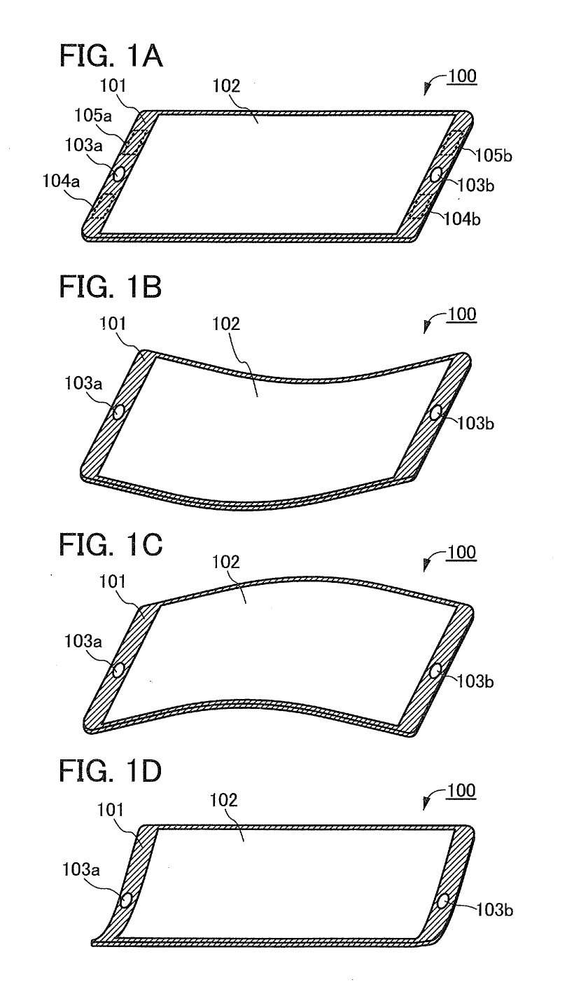

An electronic device described in this embodiment as an example is a portable information terminal capable of executing a variety of applications such as mobile phone calls, e-mailing, viewing and editing texts, music reproduction, Internet communication, and a computer game. FIG. 1A is a top perspective view of an electronic device 100. The electronic device 100 includes a housing 101, a display screen 102, a button 103a, and a button 103b.

The display screen 102 is a part of a display device which displays images including a still image and a moving image. As the display device including the display screen 102, there are a light-emitting device in which each pixel includes a light-emitting element typified by an organic light-emitting element (OLED); a liquid crystal display device; an electronic paper performing a display in an electrophoretic mode, an electronic liquid powder (registered trademark) mode, or the like; a digital micromirror device (DMD); a plasma display panel (PDP); a field emission display (FED); a surface conduction electron-emitter display (SED); a light-emitting diode (LED) display; a carbon nanotube display; a nanocrystal display; a quantum dot display; and the like. The display screen 102 of one embodiment of the present invention is a part of such a display device, and a display device provided with a flexible display screen is used in the electronic device 100.

In this embodiment, a touch panel with which data can be input by an instruction means such as a finger, a pen, or a stylus is provided as an input means on the display screen 102. Since the touch panel is provided, a region for a keyboard becomes unnecessary and thus the display screen can be provided in a large region. Moreover, since data can be input using the touch panel, a user-friendly interface can be obtained. Although the touch panel may be of any of various types such as a resistive type, a capacitive type, an infrared ray type, an electromagnetic induction type, and a surface acoustic wave type, a resistive type or a capacitive type is particularly preferable since the display screen 102 of one embodiment of the present invention can be curved.

Since the display screen 102 is flexible, the housing 101 also needs to have deformability. The housing 101 is preferably formed using an elastic resin material, a plastically deformable metal material, a combination thereof, or the like. For example, a pressed metal plate can be used for the four corners of the housing 101 and a rubber or plastic molded body can be used for the other parts. Note that although not shown, it is also possible to use a material which is not flexible for the housing 101 when only the display device including the display screen 102 has flexibility and a space is provided between the display device and the housing 101. In this case, the housing 101 may be partly provided with bellows or the like, so that the housing 101 can be stretched and shrunk as the display screen 102 is curved.

As illustrated in FIG. 1A, the electronic device 100 described in this embodiment has a rectangular shape in which a long side is longer than a short side. The reason for this is that with this shape, curving in a direction perpendicular to the long side is particularly easily performed, so that a user can feel a feature of the flexibility of the electronic device 100 more strongly. However, by a 90° turn of the electronic device 100, it can be used as a vertically oriented display device with a short side at the bottom. At this time, an attitude/direction sensing means such as an acceleration sensor may be provided in the electronic device 100, in which case the attitude/direction sensing means detects rotation of the electronic device 100 and an image displayed on the display screen 102 can be rotated 90°.

The four corners of the housing 101 are rounded. Since the housing 101 has its four corners rounded, concentration of stress at edges of the four corners due to bending or twisting can be relieved, which can lead to an improvement in durability of the display device and the electronic device 100.

Further, so that the electronic device 100 can be easily curved, the thickness of the electronic device 100 is preferably as small as possible in a range which ensures a certain strength.

The shape of the electronic device 100 which is illustrated in FIG 1A is merely an example and the present invention is not limited thereto; a square, a polygon, a circle, an ellipse, or the like can be employed as demanded by users.

The button 103a and the button 103b are provided on the housing 101 and the pair of buttons are positioned symmetrically with respect to the display screen 102. When the button 103a or 103b is pressed, a home screen can be displayed on the display screen 102. Further, the electronic device 100 may be configured such that a main power supply of the electronic device 100 which is in an on state is put into an off state, or the main power supply of the electronic device 100 which is in an off state is put into an on state with a press of the button 103a or 103b for a given time. A structure may also be employed in which a press of the button 103a or 103b brings the electronic device 100 which is in a sleep mode out of the sleep mode to a normal mode. Besides, the buttons can also be used as switches for starting a variety of functions, for example, in accordance with the length of time for pressing or by pressing the two buttons separately or at the same time. When the button 103a or 103b has a variety of functions as described above, the buttons actually provided on the housing 101 can be reduced in number so as to simplify the design of the electronic device 100. The number of buttons provided on the housing 101 is preferably made as small as possible so that the electronic device 100 of one embodiment of the present invention, which has flexibility, becomes less trouble-prone and has high reliability.

The pair of buttons 103a and 103b are preferably positioned symmetrically with respect to the display screen 102 as illustrated in FIG. 1A, in which case a user can press the button 103a or 103b and curve or twist the electronic device 100 at the same time while holding both sides of the device with both hands.

Further, the housing 101 is provided with a speaker 104a and a speaker 104b as sound output means which are positioned symmetrically with respect to the display screen 102. The speakers 104a and 104b as the sound output means can output various kinds of sounds, examples of which are a sound set for predetermined processing such as a startup sound of an operating system (OS), a sound from sound data executed in various applications, such as music or a sound from music reproduction application software or moving image reproduction application software, and an incoming e-mail alert. Specifically, in the electronic device 100 of one embodiment of the present invention, one or both of the speakers 104a and 104b may output a sound in response to curving of the display screen 102.

The two speakers (the speakers 104a and 104b) positioned symmetrically with respect to the display screen 102 as illustrated in FIG. 1A enable stereophonic reproduction and output of a sound adding to realism. Note that the number or position of the speakers is not limited to the above; one speaker or three or more speakers may be provided, and the speaker may be provided on a rear surface of the display screen 102. In the case where the speaker is positioned to overlap with the display screen 102, a speaker with flexibility is employed. At this time, a speaker including a piezoelectric element is preferably used, in which case the speaker can have a thin film shape. Although not shown, the housing 101 may be provided with a wireless device or a connector for outputting a sound to a device such as headphones, earphones, a headset, an external speaker, or an external amplifier.

Further, the housing 101 is provided with a vibration motor 105a and a vibration motor 105b as vibration means which are positioned symmetrically with respect to the display screen 102. The vibration motors 105a and 105b as the vibration means can create vibration based on data which is executed in various applications. Examples of such vibration are vibration interlocking with specific processing such as startup of the OS, vibration interlocking with input operation such as a press of the button 103a or 103b or input of data through the touch panel, vibration interlocking with arrival of e-mails, and vibration interlocking with a moving image reproduced by moving image reproduction application software. When a vibration pattern of the vibration motor 105a and that of the vibration motor 105b are different, a user can receive various kinds of information. Specifically, in the electronic device 100 of one embodiment of the present invention, one or both of the vibration motors 105a and 105b may output vibration in response to curving of the display screen 102. Note that although the housing is provided with the two vibration motors in this structure example, the number or position of the vibration motors is not limited to the example.

Although not shown, the housing 101 may be further provided with an input device such as a microphone or a camera. These devices may be positioned to overlap with the display screen 102 when having flexibility or being miniaturized enough to allow the display screen 102 to be curved.

Further, the electronic device 100 may be provided with a universal serial bus (USB) terminal, a terminal to which an AC adaptor is connected, or the like. In addition, a variety of adaptors, tuners, antennas, and the like which are compatible with a wireless local area network (LAN) or digital broadcasting may be mounted on the electronic device 100. A transceiver for optical communication using infrared rays, visible light, ultraviolet rays, or the like may be provided.

Specifically, when a variety of input-output devices are locally provided on the four corners of the electronic device 100, parts which do not have flexibility can be concentrated in the four corners, which allows the electronic device 100 to have flexibility as a whole. In the case where a non-flexible member is used for the four corners, the structural strength of the electronic device 100 increases and the usability of the electronic device 100 can be enhanced. Therefore, in the four corners of the housing 101 of the electronic device 100, it is preferable that a non-flexible member which is different from materials of the other parts be used and non-flexible parts be locally provided.

Since at least part of the electronic device 100 has flexibility, the display screen 102 can be curved or twisted. For example, the display screen 102 can be curved inward as illustrated in FIG. 1B or curved outward as illustrated in FIG. 1C along a direction parallel to the long side of the electronic device 100. Moreover, as illustrated in FIG. 1D, the display screen 102 can be curved along a direction perpendicular to the long side of the electronic device 100. Therefore, in the electronic device 100, as well as curving of the display screen 102 along various directions parallel to the display screen, twisting of the display screen 102 is possible.

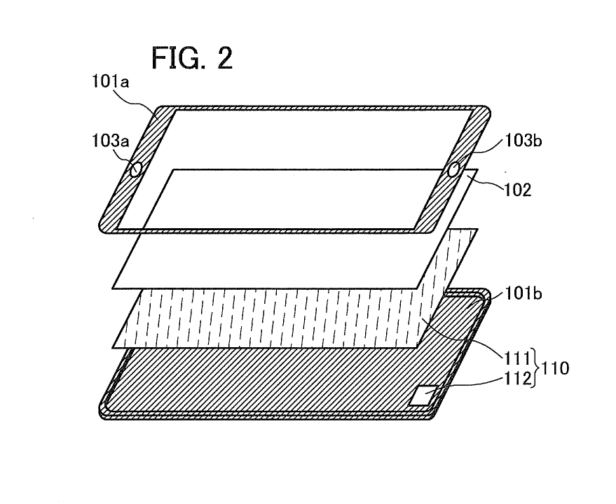

FIG. 2 is a schematic development view of the electronic device 100. For clarity, only the components which are necessary for the description here are schematically illustrated in FIG. 2.

The electronic device 100 includes a sensing portion 110 which determines a three-dimensional shape of a curved region of the electronic device 100 and calculates a parameter corresponding to a radius of curvature in the curved region. More specifically, the sensing portion 110 includes a sensor 111 for measuring a parameter defining the three-dimensional shape of the curved region of the electronic device 100, and an arithmetic portion 112 which calculates, from the parameter, a parameter corresponding to a radius of curvature. In FIG. 2, the sensor 111 is overlapped on a side opposite to that of the display screen 102. The display screen 102 and the sensor 111 are interposed between an exterior member 101a and an exterior member 101b of the housing 101. Since the sensor 111 which is as large as or larger than the display screen 102 is overlapped with the display screen 102, the sensor 111 can determine the three-dimensional shape of the whole display screen 102. The arithmetic portion 112 is fixed on an end portion of the housing 101. In FIG. 2, the arithmetic portion 112 is fixed on the exterior member 101b.

For example, as the sensor 111 of the sensing portion 110, a plurality of positional sensors which can specify a positional relation relative to each other can be provided in matrix in the vicinity of the display screen so that the positional sensor determines positional data relative to the other positional sensors. It is also possible to provide a plurality of acceleration sensors in matrix in the vicinity of the display screen as the sensor 111 of the sensing portion 110 so that the acceleration sensors measure relative change in acceleration of each region, which accompanies deformation of the display screen. The structure of the sensor 111 of the sensing portion 110 is not limited to the above and the sensor 111 can be any of a variety of sensors to which, for example, a mechanical, electromagnetic, thermal, acoustic, or chemical means is applied as long as the sensors can measure a parameter defining a three-dimensional shape of the electronic device 100. For example, an acceleration sensor, an angular velocity sensor, a vibration sensor, a pressure sensor, a gyroscope sensor, or the like can be used as the sensor 111. Alternatively, these sensors may be combined to be used. Note that these sensors may be incorporated in the touch panel provided on the display screen 102. By combining the touch panel and the sensor 111 into one component, the number of parts can be reduced, which can contribute to a reduction in the thickness of the electronic device 100.

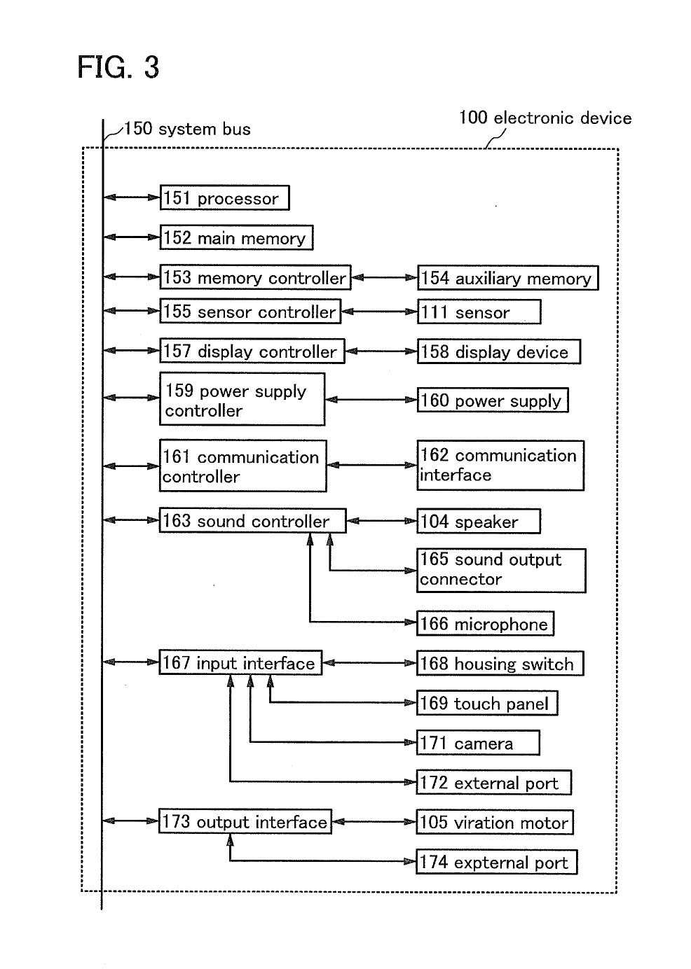

FIG. 3 is an example of a block diagram illustrating a hardware structure of the electronic device 100 in this embodiment which has flexibility. The electronic device 100 includes a processor 151, a main memory 152, a memory controller 153, an auxiliary memory 154, a sensor controller 155, the sensor 111, a display controller 157, a display device 158, a power supply controller 159, a power supply 160, a communication controller 161, a communication interface (I/F) 162, a sound controller 163, the speaker 104, a sound output connector 165, a microphone 166, an input I/F 167, a housing switch 168, a touch panel 169, a camera 171, an external port 172, an output I/F 173, the vibration motor 105, and an external port 174. Among these, the processor 151, the main memory 152, the memory controller 153, the sensor controller 155, the display controller 157, the power supply controller 159, the communication controller 161, the sound controller 163, the input I/F 167, and the output I/F 173 are electrically connected to one another through one or more system buses 150 and can communicate with one another.

The above-described structure of the electronic device 100 is merely an example. Some components such as a light source using an LED or an organic EL element (for shooting using the camera 171, for example) may be further included; alternatively, some of the above-described components may be omitted.

For the processor 151, a microprocessor such as a digital signal processor (DSP) or a graphics processing unit (GPU) can be used in addition to a central processing unit (CPU). Further, such a microprocessor may be obtained with a programmable logic device (PLD) such as a field programmable gate array (FPGA) or a field programmable analog array (FPAA). The processor 151 interprets and executes instructions from various programs to process various kinds of data and control programs.

Further, the processor 151 can process signals input from the components which are connected through the system bus 150 and generate signals to be output to the components to perform centralized control of the components connected to the system bus 150.

Note that a thin film transistor in which a channel formation region includes an oxide semiconductor and off-state current is extremely low can be used for the processor 151. Because the transistor has extremely low off-state current, by using the transistor as a switch for holding electric charge (data) flowed into a memory element, a long data retaining period can be ensured. By utilizing the above characteristics for a register or a cache memory of the processor 151, the processor 151 can operate only when needed and the data on the previous processing can be stored in the memory element in the rest of the time, so that normally off computing can be performed; thus, power consumption of the electronic device 100 can be reduced.

The main memory 152 is used as a main memory device. The main memory 152 can include a volatile memory such as a random access memory (RAM) and a nonvolatile memory such as a read only memory (ROM).

A dynamic random access memory (DRAM), for example, is used for the RAM included in the maim memory 152, and a memory space as a workspace for the processor 151 is virtually allocated and used. An operating system, an application program, a program module, program data, and the like which are stored in the auxiliary memory 154, which is a hard disk drive (HDD) or the like, are loaded into the RAM to be executed. The data, program, and program module which are loaded into the RAM are directly accessed and operated by the processor 151. Characteristics data for calculation of a parameter corresponding to a radius of curvature from the parameter which defines a three-dimensional shape of a curved region of the electronic device 100 and is measured by the sensor 111 of one embodiment of the present invention may be read, as a lookup table, from the auxiliary memory 154 which is described later, and may be stored in the main memory 152.

In the ROM, a basic input/output system (BIOS), firmware, and the like for which rewriting is not needed are stored. As the ROM, a mask ROM, a one time programmable read only memory (OTPROM), or an erasable programmable read only memory (EPROM) can be used. As an EPROM, an ultra-violet erasable programmable read only memory (UV-EPROM) which can erase stored data by irradiation with ultraviolet rays, an electrically erasable programmable read only memory (EEPROM), a flash memory, and the like can be given.

The auxiliary memory 154 incorporated in the electronic device functions as an auxiliary memory device. The auxiliary memory 154 is a recording medium having a larger capacity than the main memory 152, and is connected to the system bus 150 through the memory controller 153. The memory controller 153 functions as an interface which controls reading and writing of data from and into the auxiliary memory 154, for example. For the auxiliary memory 154, a recording medium drive such as a HDD or a nonvolatile solid state drive (SSD) device can be used, for example. Further, a microchip to which a flash memory is applied can also be used alone. Note that without the auxiliary memory 154 incorporated in the electronic device 100, a memory device provided outside the electronic device 100 may be used as the auxiliary memory 154. In this case, the memory device may be connected through an external port, or transmit and receive data wirelessly with the use of the communication I/F.

The sensor 111 includes at least a sensor for measuring a parameter defining a three-dimensional shape of a curved region of the electronic device 100 of one embodiment of the present invention. Besides, the sensor 111 may include any of a variety of sensors which measure force, displacement, position, speed, acceleration, angular velocity, rotational frequency, distance, light, liquid, magnetism, temperature, a chemical substance, a sound, time, hardness, electric field, current, voltage, electric power, radiation, flow rate, humidity, gradient, oscillation, smell, and infrared rays.

The sensor controller 155 is an interface which performs centralized control of the sensor 111. The sensor controller 155 supplies power from the power supply 160 to the sensor 111, and receives input from the sensor 111, converts it into a control signal, and outputs the signal to the system bus 150. The sensor controller 155 may handle errors made by the sensor 111 or may calibrate the sensor 111. Note that the sensor controller 155 may include a plurality of controllers which control the sensor 111.

The display device 158 is connected to the system bus 150 through the display controller 157. The display device 158 can have any of the above structures in which the display screen has flexibility. In response to drawing instructions input from the processor 151 through the system bus 150, the display controller 157 controls the display device 158 so that a predetermined image is displayed on the display screen 102 of the display device 158.

The power supply 160 supplies power to a plurality of components of the electronic device 100. As the power supply 160, for example, one or more primary batteries or secondary batteries are included. In the case of indoor use or the like, an alternate-current (AC) power supply may be used as an external power supply. Particularly in the case of using the electronic device 100 separately from the external power supply, it is favorable that the power supply have a large charge/discharge capacity which allows the electronic device 100 to be used for a long time. When the power supply 160 is charged, a charger separate from the electronic device 100 may be used. At this time, charging may be performed through wires using an AC adaptor; alternatively, charging may be performed by a wireless power feeding method such as an electric field coupling method, an electromagnetic induction method, or an electromagnetic resonance (electromagnetic resonant coupling) method. Further, since the electronic device 100 in this embodiment is flexible, it is preferable that the power supply 160 be also flexible. As a secondary battery having such a feature, for example, a lithium ion secondary battery and a lithium ion polymer secondary battery can be given. It is preferable that a laminate package be used as a jacket of the battery so that the battery has flexibility.

Further, although not shown, the power supply 160 may have a power supply management device (battery management unit: BMU). The BMU collects data on cell voltage or cell temperatures of the battery, monitors overcharge and overdischarge, controls a cell balancer, handles a deterioration state of the battery, calculates the remaining battery power (state of charge: SOC), and controls detection of a failure, for example.

The power supply controller 159 controls transmission of power from the power supply 160 to each component through the system bus 150 or a power supply line. The power supply controller 159 has a power converter or an inverter with a plurality of channels, a protection circuit, and the like. Further, the power supply controller 159 has a function of reducing power consumption. For example, after detection of no input to the electronic device 100 for a given period, the power supply controller 159 lowers clock frequency or stops input of clocks of the processor 151, stops operation of the processor 151 itself, or stops operation of the auxiliary memory, thereby controlling power supply to the components and reducing the power consumption. Such a function is performed with the power supply controller 159 alone or the power supply controller 159 interlocking with the processor 151.

The communication I/F 162 is connected to the system bus 150 through the communication controller 161. The communication controller 161 and the communication I/F 162 control, in response to instructions from the processor 151, a control signal for connecting the electronic device 100 to a computer network, and transmit the signal to the computer network. Accordingly, communication can be performed by connecting the electronic device 100 to a computer network such as the Internet (which is an infrastructure of the World Wide Web (WWW)), an intranet, an extranet, a personal area network (PAN), a local area network (LAN), a campus area network (CAN), a metropolitan area network (MAN), a wide area network (WAN), or a global area network (GAN).

In the case where communication between the electronic device 100 and another device is performed without a transmission line, i.e., wirelessly, a radio-frequency (RF) circuit may be provided in the communication I/F 162 so that an RF signal is transmitted and received. The RF circuit performs conversion between an electromagnetic signal and an electric signal in a frequency band which is set by a national law, and performs communication with another communication device wirelessly with the use of the electromagnetic signal. Several tens of kilohertz to several tens of gigahertz is a practical frequency band which is generally used. The RF circuit includes an RF circuit portion and an antenna which are compatible with a plurality of frequency bands; the RF circuit portion can include an amplifier, a mixer, a filter, a DSP, an RF transceiver, or the like. In the case of performing wireless communication, it is possible to use, as a communication protocol or a communication technology, a communications standard such as Global System for Mobile Communication (GSM) (registered trademark), Enhanced Data Rates for GSM Evolution (EDGE), Code Division Multiple Access 2000 (CDMA2000), or Wideband Code Division Multiple Access (W-CDMA), or a communications standard developed by IEEE such as Wireless Fidelity (Wi-Fi) (registered trademark), Bluetooth (registered trademark), or ZigBee (registered trademark).

Further, in the case where the electronic device 100 is used as a phone, the communication controller 161 and the communication I/F 162 control, in response to instructions from the processor 151, connection signals for connecting the electronic device 100 to a telephone line, and transmit the signal to the telephone line.

The speaker 104, the sound output connector 165, and the microphone 166, which are responsible for sound, are connected to the sound controller 163 to be connected to the processor 151 through the system bus 150. The sound controller 163 generates analog sound signals audible to a user in response to instructions from the processor 151, and outputs the signals to the speaker 104 or the sound output connector 165. Sound data input to the microphone 166 is converted into a digital signal in the sound controller 163 and processed in the sound controller 163 and the processor 151.

To the sound output connector 165, a sound output device such as headphones or a headset can be connected and a sound generated in the sound controller 163 is output to the device.

One or more buttons or switches provided on the housing (hereinafter referred to as the housing switches 168 for convenience), the touch panel 169 provided in the vicinity of the display screen 102, the camera 171, and the external port 172 to which other input components can be connected are controlled by the input I/F 167, and the input I/F 167 is connected to the processor 151 through the system bus 150.

The housing switches 168 correspond to, for example, the buttons 103a and 103b and the like which are illustrated in FIGS. 1A to 1D. A volume control button, a camera shoot button, and the like may also be included. As well as these housing switches 168, the touch panel 169, the camera 171, and the external port 172, the microphone 166 for sound input and the sensor 111 which detects change in the shape of the display screen 102 serve as user interfaces between a user and the electronic device 100.

The vibration motor 105 and the external port 174 to which another output component can be connected are controlled by the output I/F 173 and connected to the system bus 150 through the output I/F 173.

The output I/F 173 controls a period of vibration or the like in response to instructions from the processor 151 and accordingly, the vibration motor 105 vibrates. In this manner, vibrations with various vibration patterns for the several situations described above can be created.

Although not shown, as well as the vibration motor 105, a variety of output devices with which a user can perceive by the use of the five senses can be connected to the output I/F 173. Alternatively, an external output device can also be connected through the external port. For example, a light-emitting device for showing an operation status of the electronic device 100, an aroma diffuser which releases fragrance in response to vibration, or the like can be connected to the output I/F.

### [Alert Operation]

Here, the processor 151 has the function of the arithmetic portion 112 which has been described as an example with reference to FIG. 2. In other words, the processor 151 analyzes a signal which is input from the sensor controller 155 through the system bus 150 and includes a parameter defining a three-dimensional shape of a curved region of the electronic device 100, and calculates a parameter which corresponds to the address of the curved region or the radius of curvature in the curved region.

Further, the processor 151 determines whether or not to send an alert to a user depending on the obtained parameter which corresponds to the radius of curvature; in the case of generating an alert, a control signal relating to alert operation is sent to the components through the system bus 150.

Here, it is preferable that the sensor 111 can detect both outward curving of a surface of the electronic device 100 and inward curving thereof. At this time, so that whether or not to generate an alert can be determined regardless of whether the surface is curved outward or inward, the absolute value of a radius of curvature in a curved region of the electronic device 100 is preferably used.

Note that the processor 151 may calculate a radius of curvature itself, or may calculate a specific parameter corresponding to a radius of curvature. That is, irrespective of a form or a data structure, the parameter calculated in the processor 151 corresponds to a radius of curvature in a curved region of the electronic device 100. Therefore, “a parameter corresponding to a radius of curvature” which is calculated by the processor 151 can be replaced with “a value of a radius of curvature”. The following description may employ the replacement in some cases.

Further, a curvature, which is defined as the inverse of a radius of curvature, may be used as the parameter calculated by the processor 151. Because defining a radius of curvature corresponds to defining a curvature, a curvature is also included in a category of the parameter corresponding to a radius of curvature. It is therefore needless to say that the scope of the present invention also includes determining whether or not to send an alert to a user depending on a curvature or a parameter corresponding to a curvature.

The minimum value among a plurality of values of radii of curvature calculated at a plurality of addresses in a region in which the sensor 111 is provided is compared to a predetermined allowable value by the processor 151. Processing for generating an alert can be performed in the case where the calculated minimum value of the radius of curvature is smaller than the allowable value.

The calculation of the minimum radius of curvature can be performed, for example, by calculating radii of curvature from parameters defining a three-dimensional shape and obtained in the entire region in which the sensor 111 is provided, and finding the minimum value. It is also possible that the region in which the sensor 111 is provided is divided into a plurality of blocks, the local minimum value of a radius of curvature is calculated in each of the blocks, and the minimum value of a radius of curvature in the entire region is obtained by comparing the local minimum values of radii of curvature in the blocks.

Note that the processor 151 may include a microprocessor which executes the above-described processing by the arithmetic portion 112, or a microprocessor such as a CPU in the processor 151 may execute the above-described processing by the arithmetic portion 112. In this specification and the like, an object which can perform (execute) a function (processing) of the arithmetic portion 112 is referred to as the arithmetic portion 112.

Further, a program for making the electronic device 100 execute the above series of steps of processing (i.e., processing for determining a three-dimensional shape of a curved region of the electronic device 100 and processing for generating an alert when a radius of curvature in the region is smaller than the predetermined radius of curvature) is stored in the main memory 152 or the auxiliary memory 154. By reading the program with the processor 151, the series of steps of processing can be executed. The program may be stored (installed) in the auxiliary memory 154 by using a computer-readable recording medium such as a CD, a DVD, or a memory card, or a network, or may be directly executed on such a general-purpose recording medium.

The above-described procedure for processing is executed by an application program. Starting of the application may be set to be performed at the same time as startup of the operating system. The program is recorded in a computer-readable recording medium such as the auxiliary memory 154 or the main memory 152.

Further, although the program corresponds to software here, such a processing means can also be an electronic circuit or mechanical hardware.

When a user makes the curve of the electronic device 100 less sharp in response to the alert, i.e., when the processor 151 recognizes that the minimum value of a radius of curvature calculated in the entire region in which the sensor 111 is provided exceeds the allowable value, the alert operation is immediately stopped and a return to normal operation is made. For an immediate stop of the alert operation and a return to normal operation, it is preferable that in a period in which the alert operation is performed, the sensor 111 operate at all times, a signal including a parameter defining a three-dimensional shape of a curved region of the electronic device 100 be sent from the sensor controller 155 at all times, and the processor 151 analyze the signal to determine whether or not to stop the alert operation.

Any of a variety of components of the electronic device 100 can be used as an alert generator and generate the above alert by utilizing, for example, an alert display on the display screen by a display means, stopping of a display on the display screen, a sound output by the sound output means, vibration by the vibration means, or light emission by the light-emitting means.

In the case where the alert is sent to a user by performing an alert display on the display screen, instructions from the processor 151 are transmitted to the display controller 157 through the system bus 150, and the alert display on the display screen 102 of the display device 158 is performed by the display controller 157. At this time, image data or video data used for the alert display is stored in the main memory 152 or the auxiliary memory 154 in advance, read from the main memory 152 or the auxiliary memory 154 when the processor 151 determines to generate an alert, and output as an image signal or a video signal to the display controller 157.

An alert image on the display screen 102 is preferably displayed such that a user can regard the display as an alert intuitively; for example, a display of an image or video which shows the alert, inversion of colors of an image which has been displayed, a black and white presentation, a grayscale display, or a blinking display on part of or the entire region of the display screen 102 is preferably performed. Further, a user may be allowed to set an image or video used for the alert display in advance. The alert display on the display screen 102 is performed in the above manner, whereby a user can receive the alert in an effective way.

An alert can be sent to a user by stopping a display on the display screen 102. In this case, image data or video data for the alert does not need to be stored in advance; therefore, the alert can be sent to a user using a simple structure. Moreover, power supply to the display device 158 in a period in which the alert is generated can be stopped not only to reduce power consumed in this period but also to prevent a short circuit between wirings or electrodes in the display device 158 which is caused when the electronic device is curved with a radius of curvature smaller than the allowable value with power supplied. Accordingly, the reliability of the electronic device 100 can be improved.

In the case where the alert is sent to a user by outputting a sound from the sound output means such as the speaker 104 or the sound output connector 165, instructions from the processor 151 are transmitted to the sound controller 163 though the system bus 150, so that the sound controller 163 makes the sound output means such as the speaker 104 or the sound output connector 165 output an alert sound. At this time, sound data used for the alert sound is stored in the main memory 152 or the auxiliary memory 154 in advance, read from the main memory 152 or the auxiliary memory 154 when the processor 151 determines to generate an alert, and output as a sound signal to the sound controller 163.

As an alert sound output from the sound output means, a sound which is easy to be regarded by a user as an alert intuitively, such as a sound from a buzzer or a beep, is preferably used. A user can also register desired sound data as an alert sound in advance. In this manner, with a sound output from the sound output means, a user can receive an alert in an effective way. In addition, by generating an alert using a sound, even the electronic device 100 apart from a user can inform the user of the device's risk of being damaged when curved with an unexpected external force. The volume of an alert sound output from the sound output means is preferably set such that even a user apart from the device can hear the alert sound. It is more preferable that a user can freely set the volume.

In the case where the alert is sent to a user with vibration by the vibration means such as the vibration motor 105, instructions from the processor 151 are transmitted to the output I/F 173 though the system bus 150 so that the output I/F 173 makes the vibration means such as the vibration motor 105 vibrate. At this time, data on vibration patterns used for the alert is stored in the main memory 152 or the auxiliary memory 154 in advance, read from the main memory 152 or the auxiliary memory 154 when the processor 151 determines to generate an alert, and output as a vibration signal to the output I/F 173.

As a vibration pattern of the vibration for an alert which is output from the vibration means, a vibration pattern which is different from those for informing a user of the other operation statuses (operation statuses of normal operations) is preferably used. As described above, vibration can be used to make a user receive an alert intuitively. Vibration is preferably used, in which case an alert can be sent to a user even in a situation where a sound cannot be output.

Note that the means for sending an alert to a user is not limited to the above as long as it is a means which allows a user to receive an alert by the use of the five senses. For example, a light-emitting means which includes a light-emitting element such as an LED or an OLED may send an alert to a user by lighting up or blinking.

Further, as a means for generating an alert, two or more of the above means can be used at the same time. For example, the vibration motor 105 may vibrate in a specific pattern at the same time as an alert display performed on the display screen 102. When an alert is sent to a user in such a composite manner, the user can receive the alert in a more effective way.

Here, it is preferable that the processor 151 determine whether or not to generate an alert by using two or more predetermined allowable values of radii of curvature, and alerts be sent to a user in a stepwise manner. By setting a plurality of levels at which alerts are generated, an alert at a higher level can be generated in a situation where a radius of curvature is smaller, i.e., the risk of damage is higher, to effectively inform a user of the risk.

For example, a first radius of curvature and a second radius of curvature which is smaller than the first radius of curvature are set as the allowable values. When the value of the minimum radius of curvature calculated by the processor 151 is smaller than the first radius of curvature and larger than the second radius of curvature, a first alert is generated; when the value of the minimum radius of curvature calculated by the processor 151 is smaller than the second radius of curvature, a second alert is generated. Here, the first alert and the second alert are preferably generated by different means.

For example, it is possible that an alert display is performed on the display screen 102 as a first alerting means to send an alert to a user and an alert sound is generated as a second alerting means.

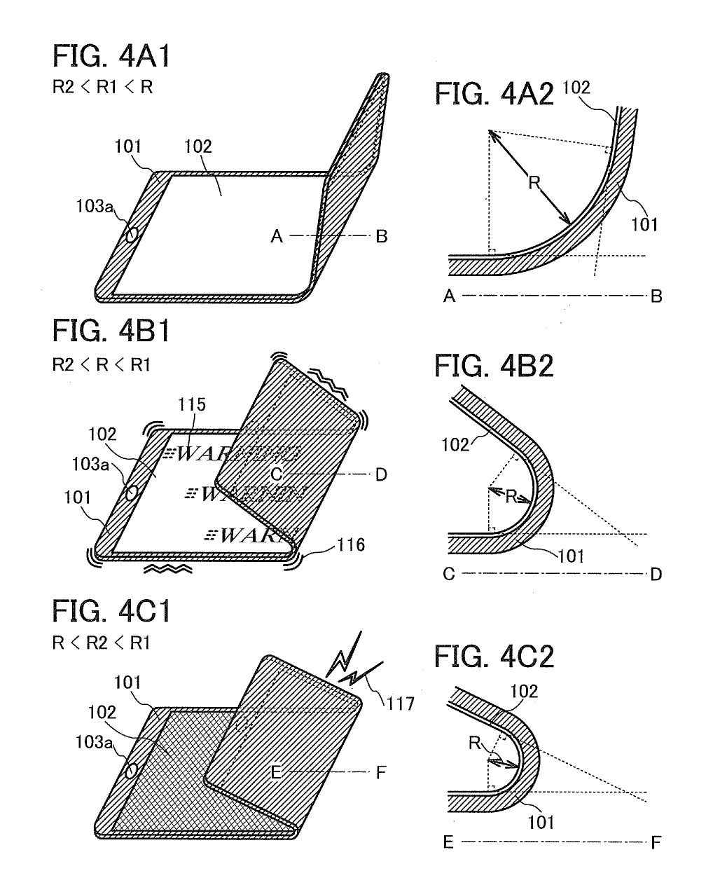

FIGS. 4A1, 4A2, 4B1, 4B2, 4C1, and 4C2 are schematic diagrams illustrating examples of a state of the electronic device 100 which is curved and alert operation which is performed depending on a radius of curvature in the curved region.

FIG. 4A1 illustrates the case where the minimum radius of curvature R of the display screen 102 is larger than a first radius of curvature R1 and a second radius of curvature R2 (R2<R1<R). FIG. 4A2 is a schematic cross-sectional diagram taken along a cutting-plane line A-B in FIG. 4A1.

In this case, since the radius of curvature R of the display screen 102 of the electronic device 100 is larger than the allowable radii of curvature, the electronic device 100 normally operates.

FIG. 4B1 illustrates the case where the minimum radius of curvature R of the display screen 102 is smaller than the first radius of curvature R1 and larger than the second radius of curvature R2 (R2<R<R1). FIG. 4B2 is a schematic cross-sectional diagram taken along a cutting-plane line C-D in FIG. 4B1.

In this case, an alert image 115 is displayed on the display screen 102 in the electronic device 100 as an alerting means. Further, the electronic device 100 produces vibration 116 with the vibration motor 105 (not illustrated). When alerts are sent to a user with two or more alerting means in this manner, the user can receive the alerts in a more effective way, whereby damage to the electronic device 100 can be prevented.

FIG. 4C1 illustrates the case where the minimum radius of curvature R of the display screen 102 is smaller than the first radius of curvature R1 and the second radius of curvature R2 (R<R2<R1). FIG. 4C2 is a schematic cross-sectional diagram taken along a cutting-plane line E-F in FIG. 4C1.

In this case, the electronic device 100 performs a stop of a display on the display screen 102 and a stop of power supply to the display device 158 (not illustrated) as alerting means. Further, the electronic device 100 outputs an alert sound 117 by the speaker 104 (not illustrated). When a display on the display screen 102 is stopped and the alert sound 117 is output at the same time in this manner, a user can be informed that an alert at a higher level is generated, whereby damage to the electronic device 100 can be effectively prevented.

Here, an allowable value of a radius of curvature used for determination of whether or not to generate an alert which is made by the arithmetic portion 112 may be set depending on an allowable radius of curvature for parts provided in portions which can be curved in the electronic device 100, and can be set to be greater than or equal to 1 mm and less than or equal to 50 mm, preferably greater than or equal to 5 mm and less than or equal to 25 mm, more preferably greater than or equal to 5 mm and less than or equal to 20 mm, for example. For example, the first radius of curvature R1 is set to 20 mm and the second radius of curvature R2 is set to 10 mm. Here, the minimum allowable value of a radius of curvature among a plurality of allowable values of radii of curvature (in the case where only one allowable value is set, the allowable value) is preferably set to a value a little larger than the limit value of the radius of curvature which causes the electronic device 100 to be damaged (for example, a value 1 mm or more larger than the limit value).

Further, a user may be allowed to set the allowable value of a radius of curvature. For example, a user may be allowed to freely set the allowable value to a value larger than the limit value of the radius of curvature which causes the electronic device 100 to be damaged. In such a case, an alert will not be generated in response to curving of the electronic device 100 as long as the radius of curvature is larger than the allowable value which a user set; accordingly, stress on a user can be reduced.

Further, a user may also be allowed to select an alerting means to be used. For example, a user can set only the vibration means or the light-emitting means as the alerting means to be used in a situation where a sound cannot be output.

Here, in the electronic device 100, alerting means each of which is used for generating an alert may be changed as time passes. For example, in the case where the electronic device 100 is curved with a radius of curvature which is smaller than a predetermined allowable value of a radius of curvature, an alert image is displayed on the display screen 102 first, and after the display of the alert image is maintained for a given period, an alert is generated by the sound output means. Note that in this case, as an alerting means operating in a period, one of or a combination of the above-described alerting means such as the display means, the vibration means, and the sound output means can be used. When the alerting means are changed as time passes, a user can receive the alerts in a more effective way.

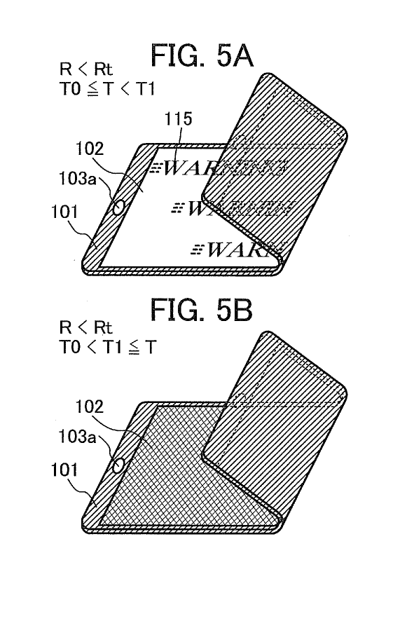

FIGS. 5A and 5B illustrate an example of the case where alerts are generated using alerting means which are changed as time passes.

FIGS. 5A and 5B each illustrate the case where the display screen 102 of the electronic device 100 is curved with a radius of curvature R smaller than an allowable radius of curvature Rt.

FIG. 5A illustrates the electronic device 100 at a time T in a period between a time TO at which curving of the display screen 102 with a radius of curvature smaller than the allowable radius of curvature Rt is detected and a time T1. At this time, the electronic device 100 sends an alert to a user by displaying the alert image 115 on the display screen 102.

Next, FIG. 5B illustrates the electronic device 100 at a time T in a period after the time T1. After the predetermined time T1, a display on the display screen 102 is stopped and power supply to the display device is stopped.

Here, the period before the alerting means are changed, i.e., the period between the time T0 and the time T1, is set to be, for example, longer than or equal to five seconds and shorter than or equal to five minutes, or longer than or equal to 10 seconds and shorter than or equal to one minute. It is preferable that a user be allowed to freely set this period.

Although one time at which the alerting means are changed is set in the above-described structure, it is possible to set two or more times so that three or more alerting means are changed as time passes. Further, when the level of the alert is raised as time passes, a user can receive the alert in a more effective way.

In the case where stopping of a display on the display screen 102 is performed as alert operation, image data which is displayed on the display screen 102 or display data such as data on a playback position at the time of reproducing a moving image is preferably stored in the main memory 152 or the auxiliary memory 154 in advance. Further, with the use of the data which is stored in advance, the display just before the stopping of the display on the display screen 102 can be immediately recovered when a user makes the radius of curvature of the electronic device 100 larger than or equal to the allowable value in response to the alert. Specifically, in the case where a moving image is reproduced, a playback position can be prevented from proceeding in a period in which a display on the display screen 102 is stopped.

Further, it is preferable that at the same time as stopping of a display on the display screen 102, power supply to the display device 158 which is provided with the display screen 102 be stopped. Even in this case, by storing display data in the main memory 152 or the auxiliary memory 154 in advance, the display just before the stopping of the display can be immediately recovered.

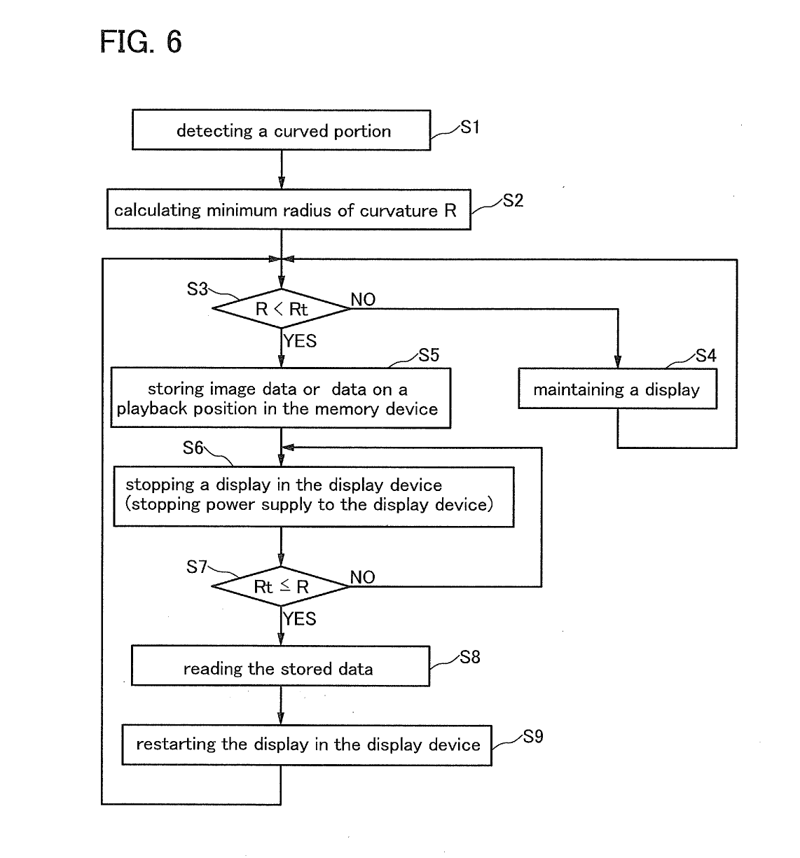

Here, with reference to FIG. 6, an example of an operation method in the case where a display on the display screen 102 is stopped when the electronic device 100 is curved with a radius of curvature less than or equal to the allowable value is described. FIG. 6 is a flow chart showing an example of operation of the electronic device 100.

First, with the use of the sensor 111, a parameter which defines the three-dimensional shape of a curved portion of the electronic device 100 is measured (S1).

Then, the arithmetic portion 112 (the processor 151) calculates radii of curvature in the curved portion of the electronic device 100 and the minimum radius of curvature R in the curved region of the electronic device 100 (S2).

Note that the processing for measuring the parameter defining the three-dimensional shape and the processing for calculating the radius of curvature R, which are described above, are alternately performed every certain period of time. After every execution of the two steps of processing, the data on the radius of curvature R is updated. The subsequent processing (processing for comparison or determination) is always performed on the basis of the latest data on the radius of curvature R.

Then, the calculated radius of curvature R and the allowable radius of curvature Rt are compared to each other (S3).

When the radius of curvature R is larger than or equal to the allowable radius of curvature Rt (R≧Rt) in S3, a display on the display screen 102 of the display device 158 is maintained (S4).

In contrast, when the radius of curvature R is smaller than the allowable radius of curvature Rt (R<Rt) in S3, first, display data such as image data which is displayed on the display screen 102 or data on a playback position in a moving image is stored in the main memory 152 or the auxiliary memory 154 (the memory device) (S5).

After the display data is stored, a display on the display screen 102 of the display device 158 is stopped (S6).

At the same time as the stopping of the display on the display screen 102, power supply to the display device 158 is preferably stopped. By stopping the power supply to the display device 158, an electrical short circuit between elements or wirings, which is caused by a too sharp curve in a state where voltage is applied to elements provided in pixels or driver circuits, can be prevented, so that a failure in the display device 158 can be suppressed.

Then, whether or not the radius of curvature R returns to a value larger than the allowable radius of curvature Rt is determined (S7).

In S7, when the radius of curvature R remains smaller than the allowable radius of curvature Rt, the state in S6, in which the display on the display screen 102 is stopped, is maintained.

In contrast, when the radius of curvature R returns to a value larger than or equal to the allowable radius of curvature Rt (Rt≦R) in S7, the processor 151 first reads the stored display data from the main memory 152 or the auxiliary memory 154 (the memory device) (S8).

After that, with the use of the display data read in S8, the display on the display screen 102 is restarted (S9). For example, an image, a display screen, or the like which has been displayed just before the stopping of the display on the display screen 102 can be immediately displayed. Alternatively, in the case where a moving image has been reproduced before the stopping of the display on the display screen 102, the moving image can be reproduced again from a scene just before the stopping of the display, using data on a playback position which is read.

The above is the description of FIG. 6.

In this manner, an alert is sent to a user by stopping of a display on the display screen 102, whereby the user can receive the alert in an effective way. In addition, when the display data just before the stopping of a display is stored in the memory device in advance, an immediate return to a display state just before the stopping of a display can be performed; therefore, the alert can be generated without stress put on a user. The stopping of power supply to the display device including the display screen 102 leads to a reduction in power consumption in a period in which the alert is generated.

The above is the description of the alert operation of the electronic device 100.

The flexible electronic device of one embodiment of the present invention can effectively send an alert to a user when curved with a radius of curvature smaller than an allowable value; therefore, damage due to curving can be effectively prevented and reliability can be improved in the electronic device.

This embodiment can be combined with any of the other embodiments disclosed in this specification as appropriate.

### Embodiment 2

In this embodiment, another mode of an electronic device of one embodiment of the present invention will be described.

Examples of the flexible electronic device of one embodiment of the present invention include various devices such as an electronic tag (also referred to as an RFID or a wireless tag), a card provided with an electronic tag, a controller for a game machine or the like, a remote controller, input devices such as a keyboard, a mouse, and a pen tablet, a portable music reproduction device, a portable sound recording device, a mobile phone, a wireless LAN device (also referred to as a mobile router), a wireless receiver, a wireless transmitter, a wireless transceiver, a variety of sensors (for sensing a temperature, a humidity, a light quantity (the amount of radiation, ultraviolet rays, or infrared rays), and the like), medical equipment such as a clinical thermometer, a heart rate meter, a sphygmomanometer, an electrocardiograph (also referred to as a monitor), and an electroencephalograph, a pedometer, a lighting device, a power transmission device, a power receiving device, a power generating device such as a solar cell, a power supply device such as a primary battery, and a power storage device and a charging device such as a secondary battery.

Owing to the flexibility, the device can have a shape that allows the device to be attached on a human body or the like, or a bracelet shape, in which case a user can attach and detach the device. Especially when the present invention is applied to the above medical equipment, an increased comfort can be offered to a user so that the user does not have a sense of wearing the device, which is preferable.

The above-described electronic device includes a display device which is provided with a display screen, e.g., the display device described in Embodiment 1. For the operation of sending an alert to a user, it is possible to utilize various means which are described above such as the sound output means, the vibration means, and the light-emitting means, as well as stopping of a display on the display screen of the display device. By using the sound output means, even when apart from a user, the electronic device can effectively inform the user that an alert is generated. Further, the vibration means or the light-emitting means is preferably used, in which case an alert can be sent to a user even in a situation where a sound cannot be output.

An alert is preferably generated by utilizing the stopping of a display on the display screen and the above alerting means at the same time, in which case it is possible to inform a user of the alert more effectively.

The flexible electronic device of one embodiment of the present invention can effectively send an alert to a user when curved with a radius of curvature smaller than an allowable value; therefore, damage due to curving can be effectively prevented and reliability can be improved in the electronic device.

This embodiment can be combined with any of the other embodiments disclosed in this specification as appropriate.

This application is based on Japanese Patent Application serial no. 2012-124468 filed with Japan Patent Office on May 31, 2012, the entire contents of which are hereby incorporated by reference.

What is claimed is:

1. An electronic device comprising:
a display portion;
a sensor configured to detect a curved region of the electronic device; and
a processor configured to compare a radius of curvature in the curved region with a first value and transmit a control signal for stopping a display in the display portion when the radius of curvature is smaller than the first value.

2. The electronic device according to claim 1, wherein a control signal for stopping power supply to the display portion is used as the control signal for stopping the display in the display portion.

3. The electronic device according to claim 1, wherein the processor is configured to store, in a memory device, display data displayed in the display portion before transmitting the control signal for stopping the display in the display portion.

4. The electronic device according to claim 1, further comprising an alert generator, wherein the processor is configured to transmit a control signal for generating an alert from the alert generator.

5. The electronic device according to claim 4, wherein the alert is at least one of a sound, vibration, and light emission.

6. The electronic device according to claim 4, wherein the processor is configured to transmit the control signal for generating the alert from the alert generator when the radius of curvature is larger than the first value and smaller than a second value larger than the first value.

7. The electronic device according to claim 4, wherein the processor is configured to transmit a control signal for an alert display in the display portion when the radius of curvature is larger than the first value and smaller than a second value larger than the first value.

8. The electronic device according to claim 4, wherein the processor is configured to transmit the control signal for stopping the display in the display portion and the control signal for generating the alert from the alert generator so that a period in which the display in the display portion is stopped overlaps with a period in which the alert is generated from the alert generator.

9. A program for controlling an electronic device comprising a display portion, a sensor, and a processor, wherein the program is configured to execute the steps of:
detecting a curved region of the electronic device by the sensor;
comparing a radius of curvature in the curved region with a first value by the processor; and
transmitting a control signal for stopping a display in the display portion by the processor when the radius of curvature is smaller than the first value.

10. A computer-readable recording medium storing the program according to claim 9.

11. The program according to claim 9, wherein a control signal for stopping power supply to the display portion is used as the control signal for stopping the display in the display portion.

12. The program according to claim 9,
wherein the electronic device further comprises a memory device, and
wherein the program is configured to further execute the step of:
storing, in a memory device, display data displayed in the display portion before transmitting the control signal for stopping the display in the display portion.

13. The program according to claim 9,
wherein the electronic device further comprises an alert generator, and
wherein the program is configured to further execute the step of:
transmitting a control signal for generating an alert from the alert generator.

14. The program according to claim 13, wherein the alert from the alert generator is at least one of a sound, vibration, and light emission.

15. The program according to claim 13, wherein the program is configured to further execute the step of:
transmitting the control signal for generating the alert from the alert generator by the processor when the radius of curvature is larger than the first value and smaller than a second value larger than the first value.

16. The program according to claim 13, wherein the program is configured to further execute the step of:
transmitting a control signal for an alert display in the display portion by the processor when the radius of curvature is larger than the first value and smaller than a second value larger than the first value.

17. The program according to claim 13, wherein the program is configured to further execute the step of:
transmitting the control signal for stopping the display in the display portion and the control signal for generating the alert from the alert generator by the processor so that a period in which the display in the display portion is stopped overlaps with a period in which the alert is generated from the alert generator.

18. A method for driving an electronic device comprising a display portion, a sensor, and a processor, wherein the method comprises the steps of:
detecting a curved region of the electronic device by the sensor;
comparing a radius of curvature in the curved region with a first value by the processor; and
transmitting a control signal for stopping a display in the display portion when the radius of curvature is smaller than the first value.
